(19) United States
(12) Patent Application Publication
(10) Pub. No.: US 2025/0320806 A1
(43) Pub. Date: Oct. 16, 2025

(54) REAMER STATUS DETECTION USING TURBINE RPM

(71) Applicant: Schlumberger Technology Corporation, Sugar Land, TX (US)

(72) Inventors: Olga Domanova, Beijing (CN); Samba Ba, Houston, TX (US); Tao Yu, Beijing (CN)

(21) Appl. No.: 19/176,747

(22) Filed: Apr. 11, 2025

Related U.S. Application Data
(60) Provisional application No. 63/634,511, filed on Apr. 16, 2024.

(51) Int. Cl. E21B 44/00; E21B 10/26; G05B 19/4065

(52) U.S. Cl. CPC E21B 44/00; E21B 10/26; G05B 19/4065

(57) ABSTRACT

A method for determining a status change of one or more reamers in a wellbore includes receiving past surface data from a first time period. The past surface data includes a past flowrate of a fluid being pumped into the wellbore. The fluid flows through a bottomhole assembly (BHA) in the wellbore. The BHA includes the one or more reamers. The method also includes receiving past downhole data from the first time period. The past downhole data includes a past number of rotations per minute of one or more turbines (past TRPM) in the BHA. The method also includes determining a relationship based upon the past surface data and the past downhole data.

### CROSS-REFERENCE TO RELATED APPLICATIONS

This application claims priority to U.S. Provisional Patent Application No. 63/634,511, filed on Apr. 16, 2024, which is incorporated by reference.

### BACKGROUND

A reamer is component in a bottom hole assembly (BHA). The reamer is configured to actuate between an open state and a closed state. In the open state, arms of the reamer may be open (e.g., radially extended) which allows the reamer to drill an oversized hole above the drill bit with a diameter bigger than the drill bit diameter. In the closed state, the reamer arms may be closed (e.g., radially retracted), and the reamer may act as a stabilizer without opening the hole diameter above the drill bit. Conventionally, a status of the reamer (e.g., opening or closing) is determined using standpipe pressure. However, this technique is not particularly sensitive and may lead to inaccurate results. Therefore, what is needed is an improved system and method for determining the status of the reamer in a wellbore.

### SUMMARY

A method for determining a status change of one or more reamers in a wellbore is disclosed. The method includes receiving past surface data from a first time period. The past surface data includes a past flowrate of a fluid being pumped into the wellbore. The fluid flows through a bottomhole assembly (BHA) in the wellbore. The BHA includes the one or more reamers. The method also includes receiving past downhole data from the first time period. The past downhole data includes a past number of rotations per minute of one or more turbines (past TRPM) in the BHA. The method also includes determining a relationship based upon the past surface data and the past downhole data.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving past surface data from a first time period. The past surface data includes a past flowrate of a fluid being pumped into a wellbore. The fluid flows through a bottomhole assembly (BHA) in the wellbore. The BHA includes one or more reamers. The operations also include receiving past downhole data from the first time period. The past downhole data includes a past number of rotations per minute of one or more turbines (past TRPM) in the BHA. The operations also include determining a relationship based upon the surface data and the downhole data. The operations also include predicting downhole data using the relationship to produce predicted downhole data. The predicted downhole data is predicted during a second time period that is after the first time period. The predicted downhole data includes a predicted number of rotations per minute of the one or more turbines (predicted TRPM). The operations also include receiving current downhole data from the second time period. The current downhole data includes a current number of rotations per minute of the one or more turbines (current TRPM). The operations also include comparing the predicted TRPM to the current TRPM to produce a comparison. The operations also include determining a status change of the one or more reamers based upon the comparison. The status change is opening or closing.

A non-transitory computer-readable medium is also disclosed. The medium stores instructions that, when executed by one or more processors of a computing system, cause the computing system to perform operations. The operations include receiving past surface data from a first time period. The past surface data includes a past flowrate of a fluid being pumped into a wellbore, a past standpipe pressure (SPP), a past mud weight, a past surface torque on a drill string in the wellbore, a past weight on a drill bit (past WOB) in the wellbore, a past depth of the drill bit, or a combination thereof. The fluid flows through a bottomhole assembly (BHA) in the wellbore. The BHA includes one or more reamers. The operations also include receiving past downhole data from the first time period. The past downhole data includes a past number of rotations per minute of one or more turbines (past TRPM) in the wellbore, a past downhole internal pressure, or both. The operations also include identifying and removing transient regions in the past surface data to produce filtered surface data. The operations also include identifying and removing outliers in the past downhole data to produce filtered downhole data. The operations also include determining a first relationship based upon the filtered surface data and the filtered downhole data. The first relationship is a one-dimensional (1D) polynomial fit. The operations also include determining a second relationship based upon the filtered surface data and the filtered downhole data. The operations also include predicting downhole data using the first relationship and/or the second relationship to produce predicted downhole data. The predicted downhole data is predicted during a second time period that is after the first time period. The predicted downhole data includes a predicted number of rotations per minute of the one or more turbines (predicted TRPM). The operations also include receiving current downhole data from the second time period. The current downhole data includes a current number of rotations per minute of the one or more turbines (current TRPM). The operations also include comparing the predicted TRPM to the current TRPM to produce a comparison. The comparison includes a combined score based upon mean square error (MSE), mean absolute percentage error (MAPE), an R2 score, a covariance, an F-statistic, a confidence interval, or a combination thereof. The comparison compares local maxima and minima of the predicted TRPM to local maxima and minima of the current TRPM. The comparison also compares a number of points of the current TRPM that are greater than or less than the confidence intervals that are based upon the predicted TRPM. The operations also include determining the status change of the one or more reamers based upon the comparison. The status change is opening or closing.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2A illustrates a downhole tool including a reamer, according to an embodiment.

FIG. 2B illustrates a cross-sectional side view of the BHA including the reamer with TRPM measurement capability, according to an embodiment. The reamer is in a closed state.

FIG. 2C illustrates a cross-sectional side view of the BHA including the reamer with TRPM measurement capability, according to an embodiment. The reamer is in an open state.

FIG. 3 illustrates a flowchart of a method for determining a status of the reamer, according to an embodiment.

FIGS. 4A and 4B illustrate graphs showing transient regions (including downlinking regions) detected in the past surface data (e.g., the flowrate), according to an embodiment.

FIG. 5 illustrates a graph showing outliers detected in the past downhole data, according to an embodiment.

FIG. 6A-6E illustrate a plurality of graphs showing washout detection, according to an embodiment.

FIGS. 7A-7D illustrate a plurality of graphs showing statistical measures that are relevant to (e.g., used to detect) a status change of the reamer, according to an embodiment.

FIGS. 8A-8D illustrate a plurality of graphs showing reamer status change detection using the method, according to an embodiment.

FIG. 9 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

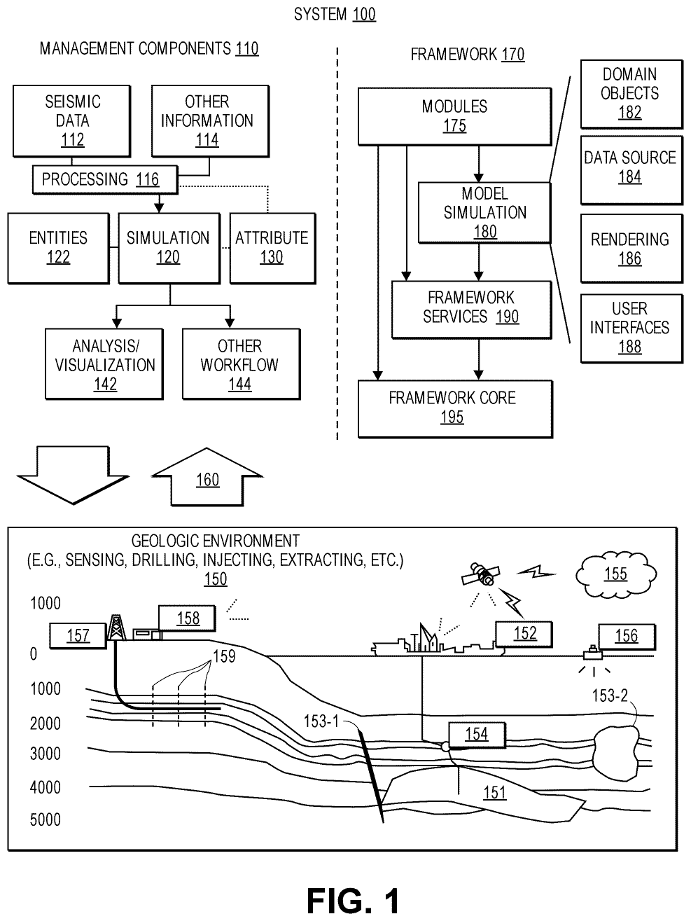

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Reamer Status Detection Using Turbine RPM

The present disclosure includes a method that may be used to detect the status of a reamer (i.e., reamer status) using turbine rotations per minute (TRPM) instead of conventional standpipe pressure (SPP). The method may also or instead use standpipe pressure (SPP) measurements and/or other measurements to detect the status of the reamer. The method may also generate a signal that may instruct or cause drilling changes in response to the determined reamer status.

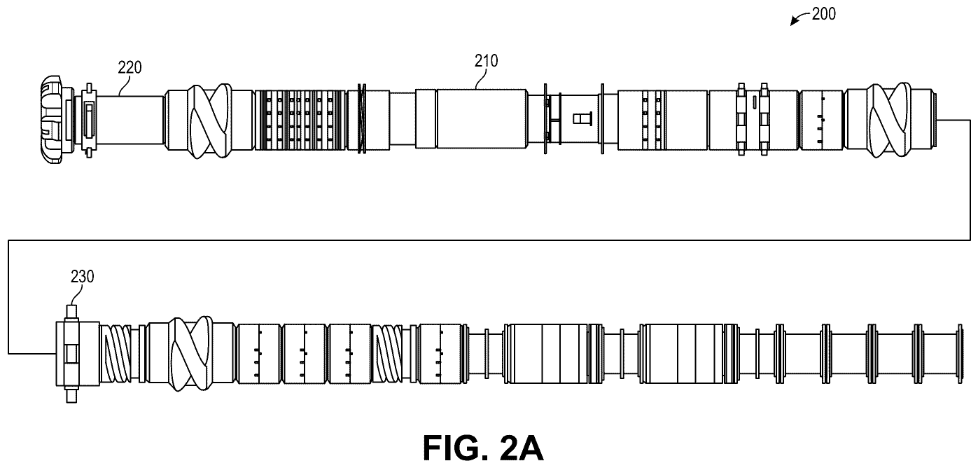

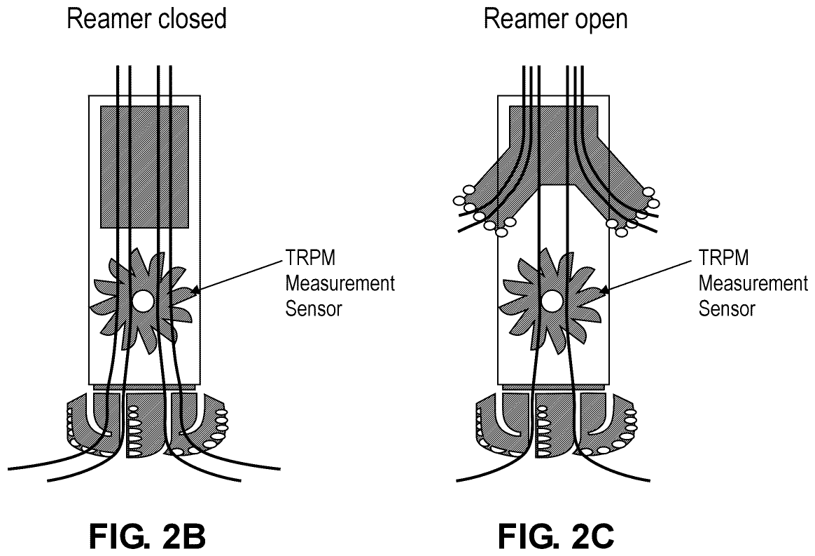

FIG. 2A illustrates a downhole tool 200, according to an embodiment. The downhole tool 200 may be run into a wellbore. The downhole tool 200 may be or include a bottom hole assembly (BHA). The downhole tool 200 may include one or more measurement and/or steering tools (two are shown: 210, 220). The downhole tool may include one or more turbines or sensors configured to capture turbine rotation per minute (TRPM) measurements, which may be sub-components installed inside the measurement and/or steering tools 210, 220.

The downhole tool 200 may also include a reamer 230. As discussed above, the reamer 230 may be configured to actuate between a first (e.g., closed) state and a second (e.g., open) state. Data from the turbine(s) (e.g., combined with surface measurements and/or other measurements) may be used to determine the status of the reamer 230. FIG. 2B illustrates a cross-sectional side view of the BHA 200 including the reamer 230 with TRPM measurement capability, according to an embodiment. The reamer 230 is in a closed state. FIG. 2C illustrates a cross-sectional side view of the BHA 200 including the reamer 230 with TRPM measurement capability, according to an embodiment. The reamer 230 is in an open state.

More particularly, the TRPM may be (e.g., directly) proportional to the flowrate through the turbine. In one embodiment, if the flowrate is maintained at a constant level at the surface, and the TRPM varies (and/or differs from the constant surface level), this may indicate that the status of the reamer has changed. For example, if the reamer is being opened, then the slope coefficient of the line may decrease, and if the reamer is being closed, then the slope coefficient may increase. The method described herein may determine (e.g., in real-time) the status change of the reamer based upon two signals: the surface flowrate (i.e., the flowrate of the fluid being pumped into the wellbore) and the TRPM. The method may be improved in terms of robustness by adding additional signals such as surface data including standpipe pressure (SPP), one or more downhole TRPM signals, downhole pressure measurements, or a combination thereof. The method may also or instead be used to determine other changes, such as mud weight in the wellbore.

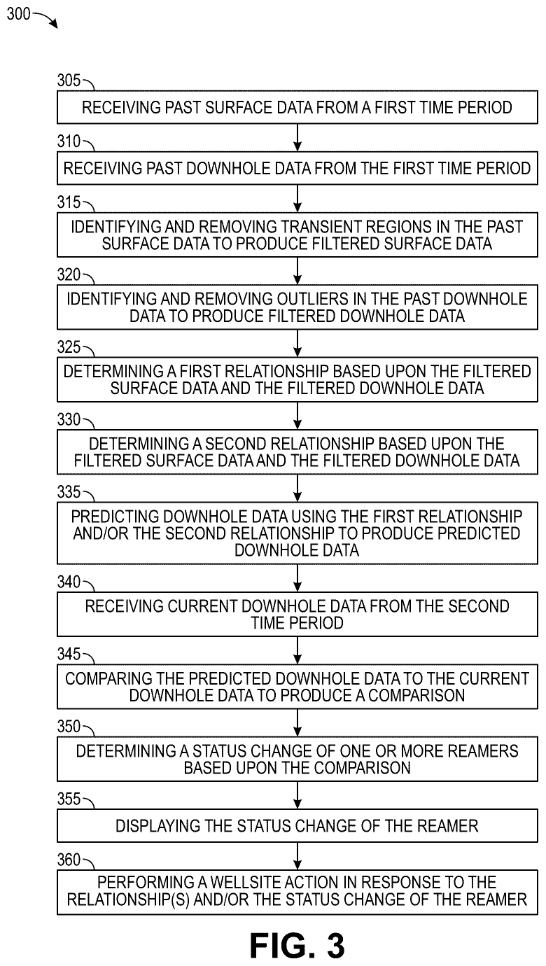

FIG. 3 illustrates a flowchart of a method 300 for determining a status change of the reamer 230, according to an embodiment. An illustrative order of the method 300 is provided below; however, one or more portions of the method 300 may be performed in a different order, simultaneously, repeated, or omitted. In at least one embodiment, the method 300 may not be based upon the standpipe pressure (SPP). The method 300 may not use (e.g., prior) information about the BHA and/or turbine. At least a portion of the method 300 may be performed by a computing system (described below).

The method 300 may include receiving first (e.g., past) surface data from a first time period, as at 305. The past surface data may include a first signal made up of a plurality of surface data points that represent(s) a past flowrate of a fluid being pumped into the wellbore. The past surface data may also or instead include a past standpipe pressure (SPP), a past mud weight, a past surface torque on a drill string in the wellbore, a past weight on a drill bit (past WOB) in the wellbore, a past depth of the drill bit, or a combination thereof. The fluid flows through a downhole tool (e.g., BHA) 200 in the wellbore. The BHA 200 may include one or more reamers 230.

The method 300 may also include receiving first (e.g., past) downhole data from the first time period, as at 310. The past downhole data may include a second signal made up of a plurality of downhole data points that represent(s) a past number of rotations per minute of one or more turbines (past TRPM) in the downhole tool 200, a past downhole internal pressure, or both.

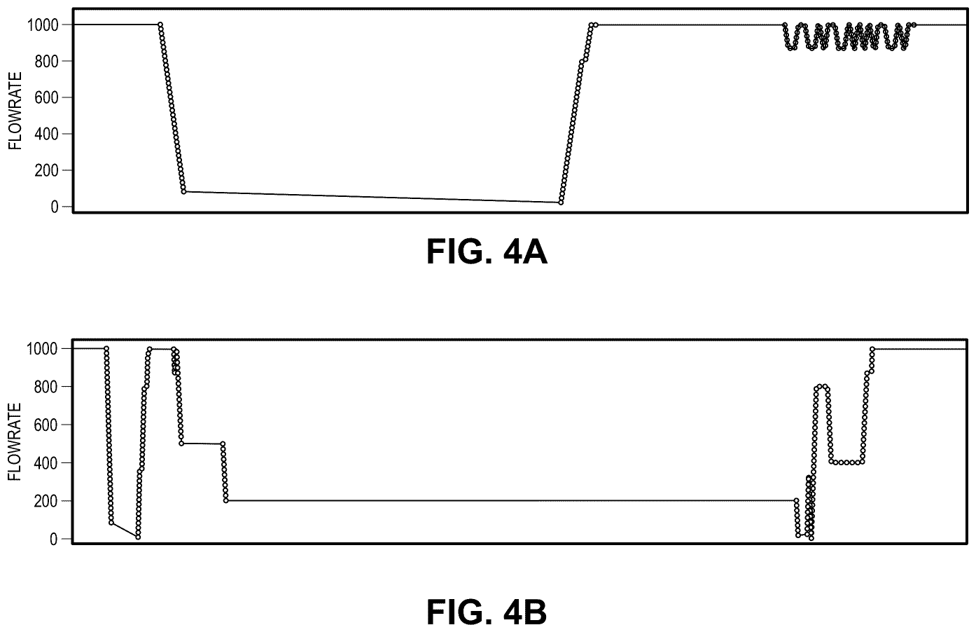

The method 300 may also include identifying and removing transient regions in the past surface data to produce filtered surface data, as at 315. The transient regions may be filtered out of (i.e., removed from) the past surface data (e.g., the flowrate signal) because they are unreliable due to the varying flowrate. Corresponding points from other channels may also be filtered out. FIGS. 4A and 4B illustrate graphs showing transient regions detected in the past surface data (e.g., the flowrate), according to an embodiment. The transient regions are indicated by the small circles. This method also captures downlinking.

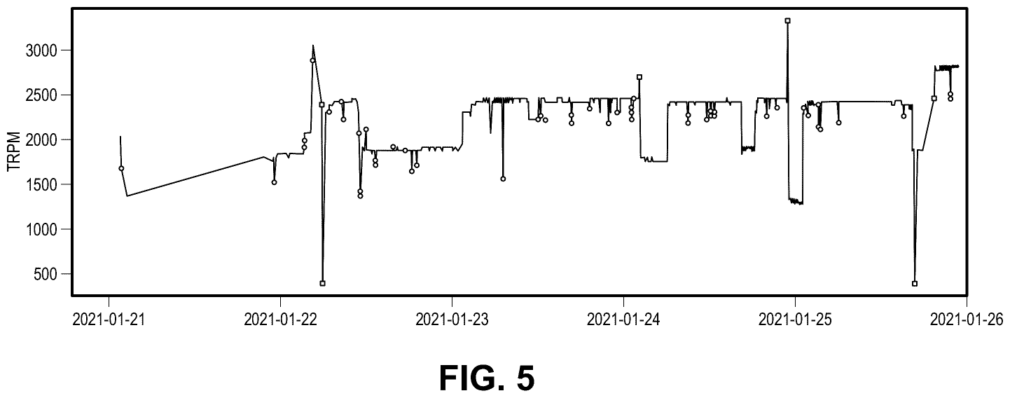

The method 300 may also include identifying and removing outliers in the past downhole data to produce filtered downhole data, as at 320. The outliers may be filtered out of the past downhole data (e.g., the TRPM signal) because they may be due to failing telemetry demodulation or failing sensors. Corresponding points from other channels may also be filtered out. FIG. 5 illustrates a graph showing outliers detected in the past downhole data, according to an embodiment. The outliers are indicated by the small squares.

The method 300 may also include determining a first relationship based upon the filtered surface data and the filtered downhole data, as at 325. The polynomial fit may be based upon the past surface data and the past downhole data. The first relationship may be or include a one-dimensional (1D) polynomial fit. The 1D polynomial fit may be described by:

$$TRPM = a ⋆ Flowrate + b \qquad ( 1 )$$

where TRPM is the past TRPM, Flowrate is the past flowrate, a is a first coefficient, and b is a second coefficient. The quality of the fit(s), the uncertainty of the linear regression fit(s), and/or numerous other statistical parameters may be evaluated. If multiple downhole TRPM measurements are received, the fit may include coefficients for each downhole measurement:

$${TRPM}_{1} = {a}_{1} ⋆ Flowrate + {b}_{1} \qquad ( 2 )$$

$${TRPM}_{2} = {a}_{2} ⋆ Flowrate + {b}_{2} \qquad ( 3 )$$

$${TRPM}_{3} = {a}_{i} ⋆ Flowrate + {b}_{i} \qquad ( 4 )$$

The method 300 may also include determining a second relationship based upon the filtered surface data and the filtered downhole data, as at 330. The second relationship may be described by:

$$SPP = {β}_{0} + {β}_{1} {TRPM}^{α} + {β}_{2} {T}_{S} + {β}_{3} WOB + {β}_{4} {Q}^{2} BD \qquad ( 5 )$$

where SPP is the past SPP, TRPM is the past TRPM, Tₛ is the past surface torque, WOB is the past WOB, Q is the past flow rate, BD is the past depth of the drill bit, α is a coefficient between 1.0 and 2.0, and β₁-β₄ are different coefficients.

The method 300 may also include predicting downhole data using the first relationship and/or the second relationship to produce predicted downhole data, as at 335. The predicted downhole data may be predicted during a second time period that is after the first time period. The predicted downhole data may include a predicted number of rotations per minute of the one or more turbines (predicted TRPM).

The method 300 may also include receiving second (e.g., current) downhole data from the second time period, as at 340. The current downhole data may include a current number of rotations per minute of the one or more turbines (current TRPM).

The method 300 may also include comparing the predicted TRPM to the current TRPM to produce a comparison, as at 345. The comparison may include a combined score based upon mean square error (MSE), mean absolute percentage error (MAPE), an R2 score, a covariance, an F-statistic, a confidence interval, or a combination thereof and other statistical measures. The comparison may compare local maxima and minima of the predicted TRPM to local maxima and minima of the current TRPM. The comparison may also or instead compare a number of points of the current TRPM that are greater than or less than the confidence intervals that are based upon the predicted TRPM. Said another way, this may include comparing the current TRPM values with those that would have been obtained if an earlier fit coefficient would have been used. For example, this may be based upon values from 5-10 points back.

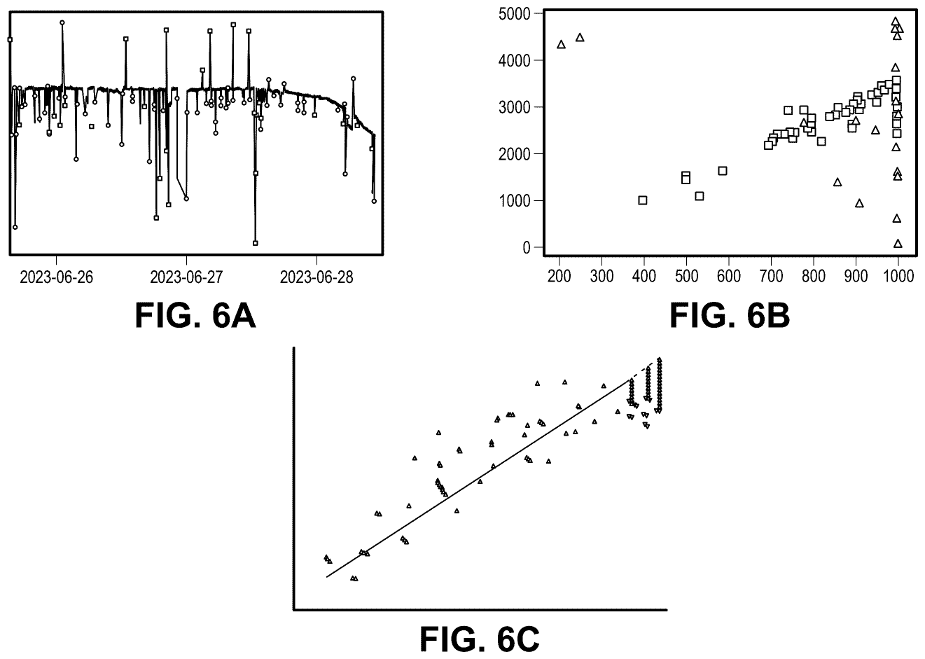

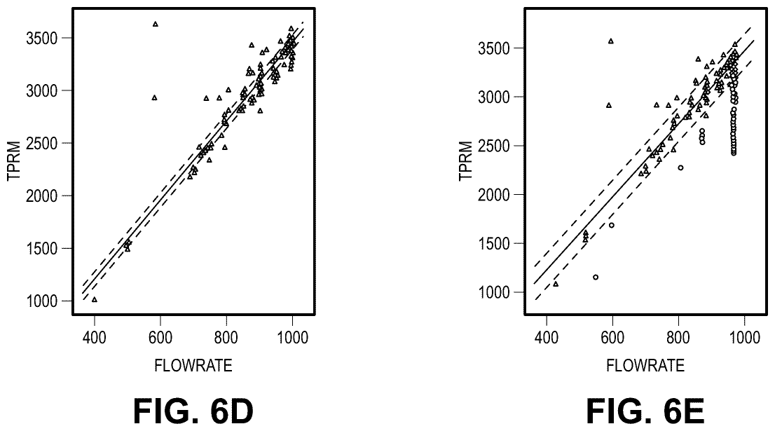

The method 300 may also include determining the status change of the one or more reamers 230 based upon the comparison, as at 350. The status change may be or include: opening and/or closing. FIGS. 6A-6E illustrate a plurality of graphs showing washout detection, according to an embodiment. More particularly, FIG. 6A shows TRPM plotted against time. At the end of this signal, a washout can be seen. FIG. 6B shows TRPM plotted against flowrate. The square marks show the points corresponding to normal functioning, while the triangular marks show the points corresponding to the washout. The relationship has changed, and washout may be detected. FIG. 6C shows TRPM plotted against flowrate. The majority of points correspond to the reamer being closed (e.g., polynomial fit to the straight line). Once the reamer is opened, the relationship between the flowrate and TRPM has changed, and the new incoming points may be below this original 1D polynomial fit. FIG. 6D shows the TRPM plotted against flowrate before the washout event or before the reamer is opened. The confidence intervals of this polynomial fit are shown with dashed lines. FIG. 6E shows TRPM plotted against flowrate in the case of a washout or after the reamer is opened. The relationship between TRPM and flowrate has changed, and the new incoming points with circular marks are outside of the confidence intervals shown by dotted lines, which have become much wider than in the FIG. 6D.

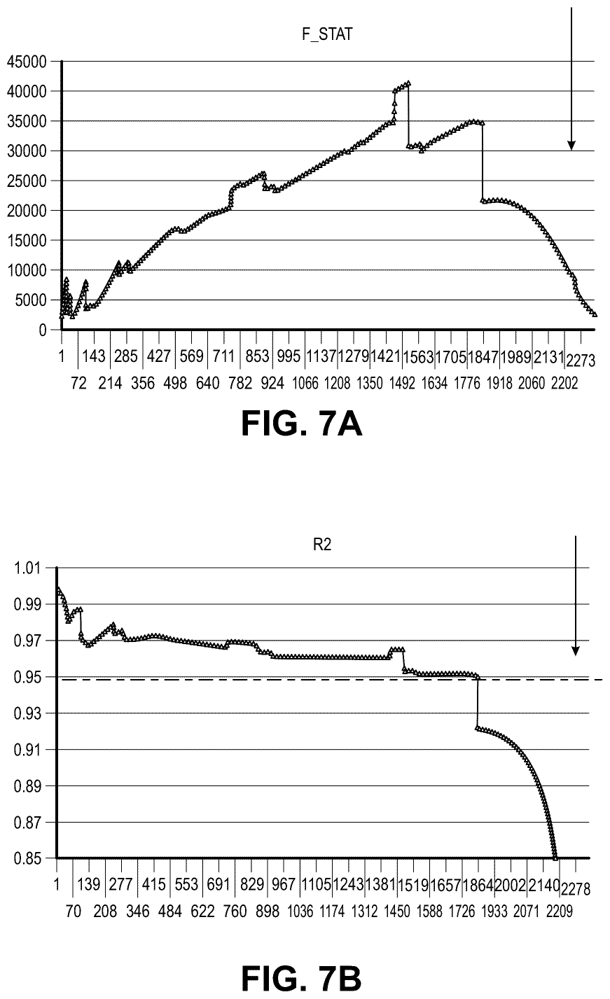

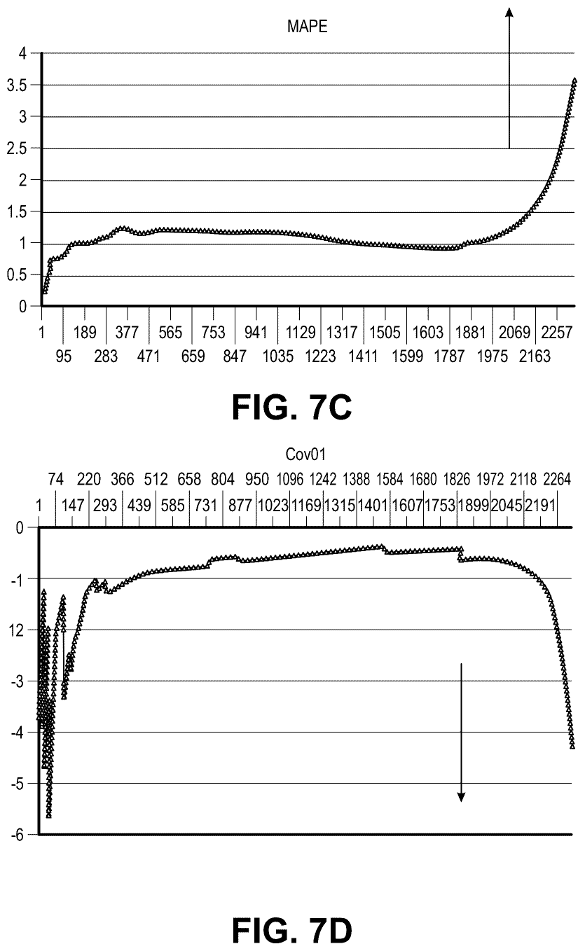

Determining the status change of the reamer 230 may be similar to the washout detection. For the closing, a user may expect points larger than using the previous fit. FIGS. 7A-7D illustrate a plurality of graphs showing some example statistical measures that may be relevant to (e.g., used to detect) a status change of the reamer 230, according to an embodiment. More particularly, FIG. 7A shows F statistics and how they decrease in cases of a reamer status change and washout, FIG. 7B shows an R squared score and how it decreases in cases of washout or reamer status change, FIG. 7C shows MAPE (mean average percentage error) and how it increases in cases of washout or reamer status change, and FIG. 7D shows a covariance between flowrate and TRPM and how it decreases in cases of washout or reamer status change.

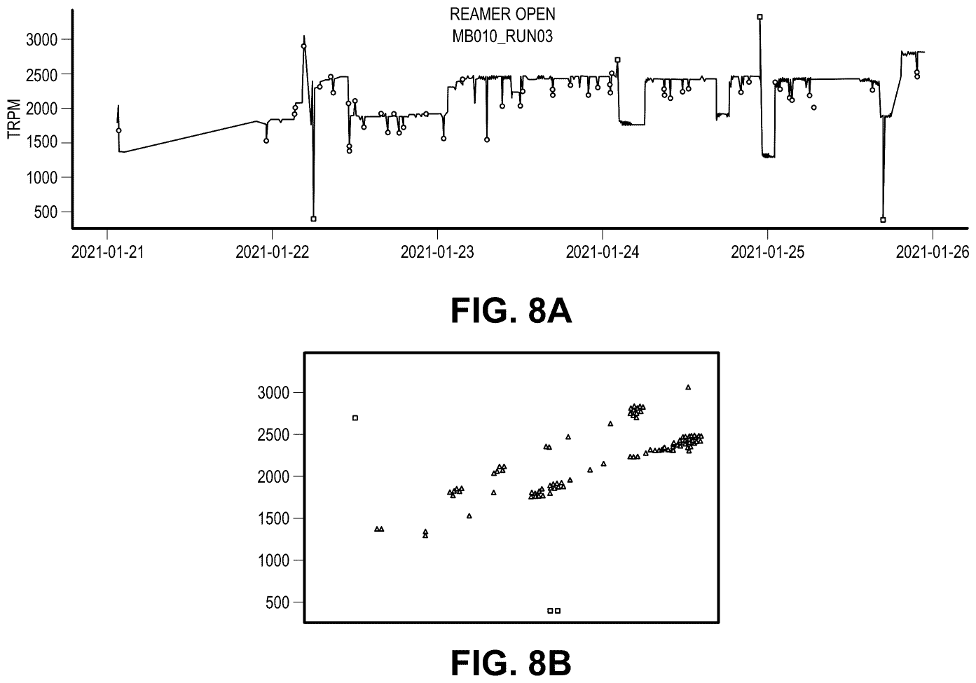

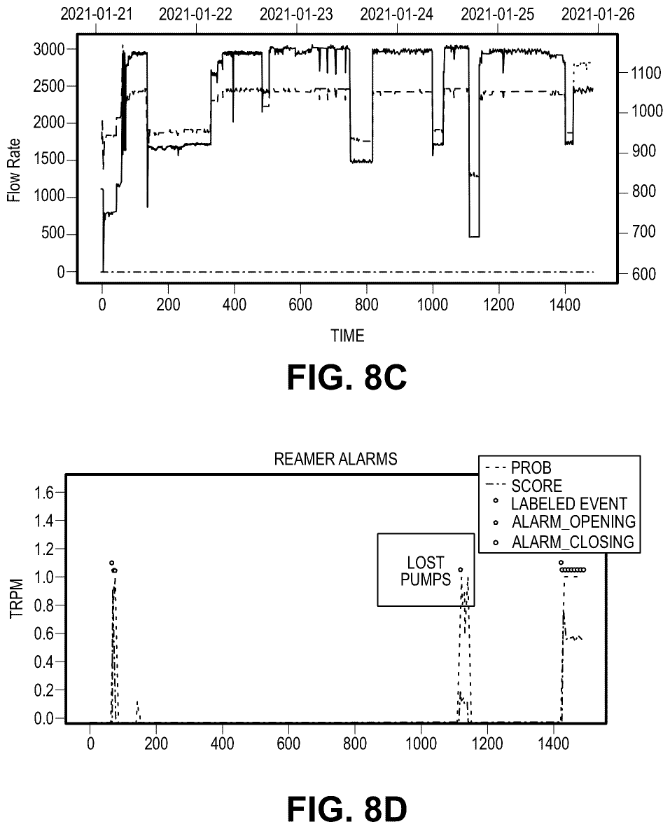

FIGS. 8A-8D illustrate a plurality of graphs showing reamer status change detection using the method 300, according to an embodiment. Both labelled events have been detected, as well as lost pumps. More particularly, FIG. 8A shows TRPM plotted against time, and the detected outliers are shown with circular markers. FIG. 8B shows TRPM plotted against flowrate with two sets of points corresponding to the reamer 230 being open or closed. FIG. 8C shows TRPM and flowrate plotted against time. FIG. 8D shows the reamer status change detection principle with computed probabilities and statistical measures.

The method 300 may also include displaying the predicted TRPM, the current TRPM, and/or the status change of the reamer, as at 355.

The method 300 may also include performing a wellsite action in response to the relationship(s) and/or the status change of the reamer, as at 360. The wellsite action may be or include generating and/or transmitting a signal (e.g., using a computing system) that recommends, instructs, or causes a physical action to occur. The wellsite action may also or instead include performing the physical action. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

In another example, in response to the reamer opening, the action may be or include changing the collar rotation per minute RPM to make sure that the extra cuttings generated by the reamer opening the hole are transported efficiently to the surface. The action may also be to increase the WOB to make sure enough weight is transferred to the drill bit and the reamer for more efficient hole penetration. In yet another example, in response to the reamer closing, the action may be or include changing the collar RPM or changing the WOB to accommodate the new state and make sure that too much WOB is not put on the drill bit in order to avoid damaging the drill bit.

### Exemplary Computing System

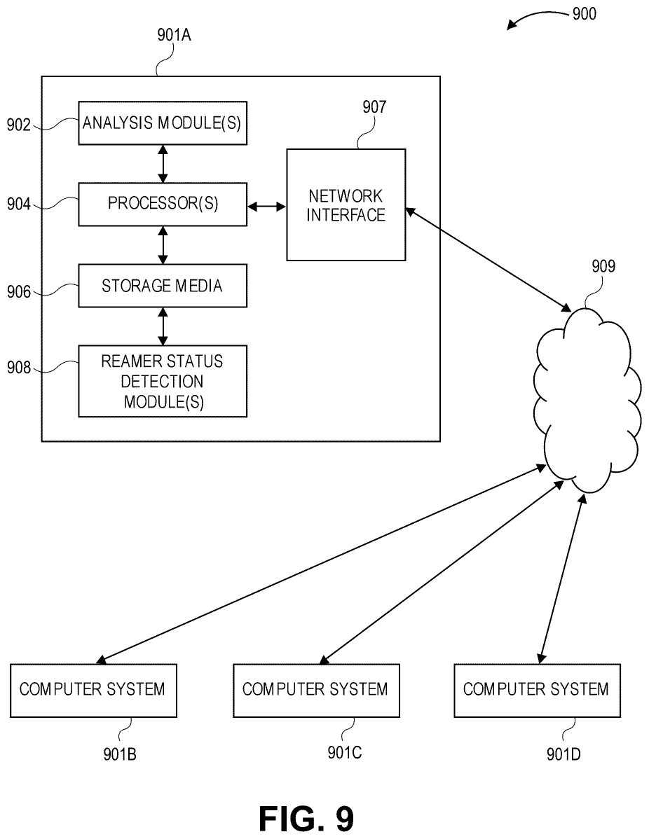

In some embodiments, the methods of the present disclosure may be executed by a computing system. FIG. 9 illustrates an example of such a computing system 900, in accordance with some embodiments. The computing system 900 may include a computer or computer system 901A, which may be an individual computer system 901A or an arrangement of distributed computer systems. The computer system 901A includes one or more analysis modules 902 that are configured to perform various tasks according to some embodiments, such as one or more methods disclosed herein. To perform these various tasks, the analysis module 902 executes independently, or in coordination with, one or more processors 904, which is (or are) connected to one or more storage media 906. The processor(s) 904 is (or are) also connected to a network interface 907 to allow the computer system 901A to communicate over a data network 909 with one or more additional computer systems and/or computing systems, such as 901B, 901C, and/or 901D (note that computer systems 901B, 901C and/or 901D may or may not share the same architecture as computer system 901A, and may be located in different physical locations, e.g., computer systems 901A and 901B may be located in a processing facility, while in communication with one or more computer systems such as 901C and/or 901D that are located in one or more data centers, and/or located in varying countries on different continents).

A processor may include a microprocessor, microcontroller, processor module or subsystem, programmable integrated circuit, programmable gate array, or another control or computing device.

The storage media 906 may be implemented as one or more computer-readable or machine-readable storage media. Note that while in the example embodiment of FIG. 9 storage media 906 is depicted as within computer system 901A, in some embodiments, storage media 906 may be distributed within and/or across multiple internal and/or external enclosures of computing system 901A and/or additional computing systems. Storage media 906 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 900 contains one or more reamer status detection module(s) 908. In the example of computing system 900, computer system 901A includes the reamer status detection module 908. In some embodiments, a single reamer status detection module may be used to perform some aspects of one or more embodiments of the methods disclosed herein. In other embodiments, a plurality of reamer status detection modules may be used to perform some aspects of methods herein.

It should be appreciated that computing system 900 is merely one example of a computing system, and that computing system 900 may have more or fewer components than shown, may combine additional components not depicted in the example embodiment of FIG. 9, and/or computing system 900 may have a different configuration or arrangement of the components depicted in FIG. 9. The various components shown in FIG. 9 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 900, FIG. 9), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for determining a status change of one or more reamers in a wellbore, the method comprising:
receiving past surface data from a first time period, wherein the past surface data comprises a past flowrate of a fluid being pumped into the wellbore, wherein the fluid flows through a bottomhole assembly (BHA) in the wellbore, and wherein the BHA comprises the one or more reamers;
receiving past downhole data from the first time period, wherein the past downhole data comprises a past number of rotations per minute of one or more turbines (past TRPM) in the BHA; and
determining a relationship based upon the past surface data and the past downhole data.

2. The method of claim 1, wherein the past surface data also comprises a past standpipe pressure (SPP), a past mud weight, a past surface torque on the BHA, a past weight on a drill bit (past WOB) of the BHA, a past depth of the drill bit, or a combination thereof.

3. The method of claim 1, wherein the past downhole data also comprises a past downhole internal pressure.

4. The method of claim 1, wherein the relationship comprises a one-dimensional (1D) polynomial fit including the past TRPM and the past flowrate.

5. The method of claim 1, further comprising predicting downhole data using the relationship to produce predicted downhole data.

6. The method of claim 5, wherein the predicted downhole data is predicted during a second time period that is after the first time period, and wherein the predicted downhole data comprises a predicted number of rotations per minute of the one or more turbines (predicted TRPM).

7. The method of claim 6, further comprising:
receiving current downhole data from the second time period, wherein the current downhole data comprises a current number of rotations per minute of the one or more turbines (current TRPM);
comparing the predicted TRPM to the current TRPM to produce a comparison; and
determining the status change of the one or more reamers based upon the comparison, wherein the status change is opening or closing.

8. The method of claim 7, wherein the comparison comprises a combined score based upon mean square error (MSE), mean absolute percentage error (MAPE), an R2 score, a covariance, an F-statistic, a confidence interval, or a combination thereof, wherein the comparison compares local maxima and minima of the predicted TRPM to local maxima and minima of the current TRPM, and wherein the comparison also compares a number of points of the current TRPM that are greater than or less than the confidence intervals that are based upon the predicted TRPM.

9. The method of claim 7, further comprising displaying the comparison and the status change.

10. The method of claim 1, further comprising performing an action in the wellbore and/or using the BHA in response to the relationship.

11. A computing system, comprising:
one or more processors; and
a memory system comprising one or more non-transitory computer-readable media storing instructions that, when executed by at least one of the one or more processors, cause the computing system to perform operations, the operations comprising:
receiving past surface data from a first time period, wherein the past surface data comprises a past flowrate of a fluid being pumped into a wellbore, wherein the fluid flows through a bottomhole assembly (BHA) in the wellbore, and wherein the BHA comprises one or more reamers;
receiving past downhole data from the first time period, wherein the past downhole data comprises a past number of rotations per minute of one or more turbines (past TRPM) in the BHA;
determining a relationship based upon the surface data and the downhole data;
predicting downhole data using the relationship to produce predicted downhole data, wherein the predicted downhole data is predicted during a second time period that is after the first time period, and wherein the predicted downhole data comprises a predicted number of rotations per minute of the one or more turbines (predicted TRPM);
receiving current downhole data from the second time period, wherein the current downhole data comprises a current number of rotations per minute of the one or more turbines (current TRPM);
comparing the predicted TRPM to the current TRPM to produce a comparison; and
determining a status change of the one or more reamers based upon the comparison, wherein the status change is opening or closing.

12. The computing system of claim 11, wherein the operations further comprise:
identifying and removing transient regions in the past surface data to produce filtered surface data;
identifying and removing outliers in the past downhole data to produce filtered downhole data,
wherein the first relationship is based upon the filtered surface data and the filtered downhole data.

13. The computing system of claim 11, wherein the relationship is between the past TRPM and the past flowrate.

14. The computing system of claim 11, wherein the relationship is between a past stand pipe pressure (SPP), the past TRPM, a past surface torque, a past weight on drill bit (past WOB), the past flowrate, and a past depth of the drill bit.

15. The computing system of claim 14, wherein the relationship comprises at least four different coefficients.

16. A non-transitory computer-readable medium storing instructions that, when executed by one or more processors of a computing system, cause the computing system to perform operations, the operations comprising:
receiving past surface data from a first time period, wherein the past surface data comprises a past flowrate of a fluid being pumped into a wellbore, a past standpipe pressure (SPP), a past mud weight, a past surface torque on a drill string in the wellbore, a past weight on a drill bit (past WOB) in the wellbore, a past depth of the drill bit, or a combination thereof, wherein the fluid flows through a bottomhole assembly (BHA) in the wellbore, and wherein the BHA comprises one or more reamers;
receiving past downhole data from the first time period, wherein the past downhole data comprises a past number of rotations per minute of one or more turbines (past TRPM) in the wellbore, a past downhole internal pressure, or both;
identifying and removing transient regions in the past surface data to produce filtered surface data;
identifying and removing outliers in the past downhole data to produce filtered downhole data;
determining a first relationship based upon the filtered surface data and the filtered downhole data, wherein the first relationship comprises a one-dimensional (1D) polynomial fit;
determining a second relationship based upon the filtered surface data and the filtered downhole data;
predicting downhole data using the first relationship and/or the second relationship to produce predicted downhole data, wherein the predicted downhole data is predicted during a second time period that is after the first time period, and wherein the predicted downhole data comprises a predicted number of rotations per minute of the one or more turbines (predicted TRPM);
receiving current downhole data from the second time period, wherein the current downhole data comprises a current number of rotations per minute of the one or more turbines (current TRPM);
comparing the predicted TRPM to the current TRPM to produce a comparison, wherein the comparison comprises a combined score based upon mean square error (MSE), mean absolute percentage error (MAPE), an R2 score, a covariance, an F-statistic, a confidence interval, or a combination thereof, and wherein the comparison compares local maxima and minima of the predicted TRPM to local maxima and minima of the current TRPM, wherein the comparison also compares a number of points of the current TRPM that are greater than or less than the confidence intervals that are based upon the predicted TRPM; and
determining a status change of the one or more reamers based upon the comparison, wherein the status change is opening or closing.

17. The non-transitory computer-readable medium of claim 16, and wherein the 1D polynomial fit comprises:
$$TRPM = a ⋆ Flowrate + b$$
where TRPM is the past TRPM, Flowrate is the past flowrate, a is a first coefficient, and b is a second coefficient.

18. The non-transitory computer-readable medium of claim 16, wherein the second relationship comprises:
$$SPP = {β}_{0} + {β}_{1} {TRPM}^{α} + {β}_{2} {T}_{S} + {β}_{3} WOB + {β}_{4} {Q}^{2} BD$$
where SPP is the past SPP, TRPM is the past TRPM, Tₛ is the past surface torque, WOB is the past WOB, Q is the past flowrate, BD is the past depth of the drill bit, α is a coefficient between 1 and 2, and β₁-β₄ are different coefficients.

19. The non-transitory computer-readable medium of claim 16, wherein the operations further comprise displaying the predicted TRPM, the current TRPM, and the status change of the reamer.

20. The non-transitory computer-readable medium of claim 16, wherein the operations further comprise performing a wellsite action in response to the status change of the reamer, wherein the wellsite action comprises generating and/or transmitting a signal that recommends, instructs, or causes a physical action to occur in the wellbore and/or to the BHA.
